(19) United States
(12) Patent Application Publication
(10) Pub. No.: US 2017/0099820 A1
(43) Pub. Date: Apr. 13, 2017

(54) SCENT RELEASE TAB

(71) Applicant: Chemsultants International Inc., Mentor, OH (US)

(72) Inventors: Berryinne Decker, Macedonia, OH (US); Brandon S. True, Parma, OH (US); Stanley Dale Harpstead, Arden Hills, MN (US)

(73) Assignee: CHEMSULTANTS INTERNATIONAL INC., Mentor, OH (US)

(21) Appl. No.: 14/940,435

(22) Filed: Nov. 13, 2015

Related U.S. Application Data
(60) Provisional application No. 62/079,752, filed on Nov. 14, 2014.

(51) Int. Cl. A01K 85/01; C09J 7/02; A01N 25/34; A01N 25/10; A01K 99/00; A01N 37/44

(52) U.S. Cl. CPC A01K 85/01; A01K 99/00; A01N 37/44; A01N 25/34; A01N 25/10; C09J 7/02

(57) ABSTRACT

A scent tab has an active layer, an adhesive layer, a barrier layer, and a removable release liner adjacent to the adhesive layer. A scented fishing lure has a fishing lure and a scent tab having an active layer which has an active agent, a barrier layer, and an adhesive layer and the adhesive layer of the scent tape reversibly secures the scent tape to the fishing lure.

### CLAIM OF PRIORITY

This application claims priority from Provisional Patent Application Ser. No. 62/079,752, filed on Nov. 14, 2014, the entirety of which is hereby incorporated by reference.

### BACKGROUND OF THE DISCLOSURE

The disclosure relates to fish lures. More particularly, it relates to a scent release tab or tape which is used in conjunction with fish lures to attract fish by dispensing a scent into the water.

The disclosure relates to embodiments for the delivery of low doses of an active agent to target local environment around a fish lure. One embodiment for the delivery comprises chemical association of the active agent with free carboxylic acids of a film.

The disclosure specifically relates to a fishing lure attachment that scent releases bait scents or olfactory stimulants that attract fish to the lure. In particular, there is provided a hydrophilic polymeric film having a controlled rate of release and dispersion of stimulatory agents. The film, which may also contain natural and artificial attractants, preservatives, dyes, pigments, and other florescent attractants, is comprised of polymers such as polyacrylic acid and polyurethane such that it can be attached to the surface of a lure using an adhesive.

To appreciate the value of scent release technology for the sport of fishing, understanding the natural activity of fish and their olfactory senses is needed. Fish have evolved in a world that is immersed or dissolved in water. This means that all their sensory inputs are moderated by a liquid medium. Fish use auditory, visual, tactile and chemical signals to interact with their environment. Sound waves propagate more rapidly and further in water than in air. Light waves that are visible to humans in air diminish as the depth of the water column increases. The mechanical sense of touch in the human finger has great sensitivity and specificity, where the mechanical sensitivity of fish is moderated by the mass of the water surrounding the fish. As a result, anglers have used bait or lures that interact with all of these senses to attract and catch fish. However, what humans see, feel, hear, and smell is not the same as what a fish feels, hears, smells, and sees.

One recent feature that is increasingly added to the repertoire of the angler is the use of lures or baits that stimulate the chemical sensory system in fish. As in animals that walk on land, fish use a chemosensory system to identify food, mates, predators and habitat. The neuroanatomical systems used to capture the presence of dissolved chemicals are primarily associated with the senses of smell and taste.

Attractants can be divided into three categories: applied scents, preformed scents, and scent impregnated plastics.

Applied scents can best be described as manufactured liquids, aerosols and pastes which are applied to lures in order to enhance smell and taste. Applied scents disperse quickly and lose effectiveness in several minutes. Applied scents are messy and cumbersome to apply and must be re-applied more often. Lures must be cleaned properly after using applied scents or the lure will become unusable. Some manufactures apply oils and salt to the scents hoping that the bait will taste like natural bait, even though scent chemoreceptors for oil based types of molecules have not been identified or cannot be smelled by fish due to their insensitivity to water insoluble materials. The present disclosure is directed to a water hydratable film that stabilizes and releases chemo attractants in a controlled manner.

Preformed scents are moldable and manufactured to be fished on a hook. They appear most typically as dough, morsel, or nugget and are formed around a hook. Preformed baits are usually designed to retain their effectiveness for longer periods than liquid attractants although they also suffer performance problems when their outside layer has depleted its attractants. Moldable baits cannot be used with lures.

Scent impregnated plastics are not as powerful smelling as liquid attractants or preformed baits, but can be more visually stimulating to fish when molded as a rubber worm or grub. The plastic material incorporates the scent and the scent can only be dispersed after the scent is in the water. Due to heat and humidity they cannot be allowed to dry, as they will not re-hydrate. The present disclosure is directed to a scent impregnated into a re-hydratable film to be attached to the lure.

There are a number of applied scent technologies available that are designed to enhance a lure. Some of these have been developed to recharge scented soft baits, but others have been specifically modified to include oils to enhance the ability of the scent to stay with the lure. In most cases the scent has to be reapplied frequently. Several of these solutions restrict their ability to provide amino acids into the surrounding water. Specifically, about 1 ml (much more than would be sprayed on to a lure) of scent was placed into about 49 ml of water (this is a very small volume about half the size of a tube of toothpaste). This essentially dilutes the scent down to about 2% of its original concentration. The water was then assayed for amino acids in a sophisticated laboratory that tests for free amino acids in medical patients. When this was performed over multiple products, it was found that no amino acids were measurable in the water when there were oils in the mixture (i.e., two of the eight solutions tested); even when a lot of attractant or scent was used in a small water volume. In the water based solutions there were variable amounts of amino acids present. These solutions tested produced concentrations that average 1000 mg/L; with a range of 28 mg/L to 4464 mg/L. These solutions tested averaged six different amino acids released in the solutions (range 2 to 10; the only one in common was L-glycine).

Fish detect, discriminate and respond to a wealth of chemical stimuli in their environment. Notably, most of the chemical compounds the fish smell and that are found in water are relatively unspecialized metabolic products. Chemoreception is basic to meeting most of their biological needs, including those related to reproduction, social interaction, acquiring food and shelter and to avoid predators. Of course this is particularly true for fish in waters with low levels of light. Fish also rely on all of their senses, including vision, odor detection (smell) and hearing (detection of movement) for survival in their environment. If they are good at using these sensory skills, they are more likely to grow into mature fish.

Most species of fish are highly mobile and exhibit a variety of complex behaviors, many of which depend on them having information about their environment. A variety of studies have demonstrated that the chemical nature of a salmon's stream odor is learned and imprinted as they grow and then migrate to the sea. The odors they have learned are complex and comprise a mixture of compounds from minerals, plants and other animals. Fish are adept at using chemicals to identify and locate food, even in turbid, deep or dark waters. Fish also have an outstanding ability to recognize chemicals associated with a preferred food and to utilize this sensory input to refine their selection of a potential meal.

While there are undoubtedly species differences in sensitivity to classes of chemical stimuli, there are innate abilities within all fish to learn certain types of stimuli. In the natural world, most feeding chemical stimuli appear to be discriminated as complex mixtures of relatively common metabolic products, and L-amino acids are the most important of these. Amino acids appear to be universally used by fish as a chemical cue for survival. Amino acids are the building blocks of proteins and no living organism can survive without them. While most amino acids can be made by the fish with adequate sources of energy, there are several amino acids that are only available to the growing fish through is consumption of food. Electrophysiological studies (measurements of individual nerves in the laboratory) demonstrate that fish olfactory systems detect all primary L-amino acids with high sensitivity (1 part per billion) and specificity.

Fish have well developed abilities to recognize and learn natural chemical cues. As the fish mature and grow it is also apparent that combinations of odorants can be learned and identified as distinct ‘bouquets’ and result in selective feeding behavior. Feeding studies have provided evidence of the ability of fish to discriminate and learn complex chemical mixtures. Fishermen and behavioral ecologists have found many examples of fish that develop the ability to recognize and select especially desirable food items as their abundance fluctuates in the environment. To catch the more mature fish, color and action may not be sufficient, the potential prey must also trigger the fish's olfactory system.

Fish use sensory capabilities that are common to most animals, including man within their environment. Anglers try to enhance the visual appeal of lures by using a wide array of colors. They have also added sound chambers to increase the noise that baits give off as they move through the water. More recently the focus has been increasingly placed on developing additives that actually enhance the odor appeal of lures.

It is clear that there are times where the presentation of artificial lure does not permit much time for a fish to smell bait while it passes through the visual field. However, there are also times where the fish catches sight of a lure and then slowly turns to follow as it moves through the water. But the fish doesn't strike and eventually slowly turns away because fish may not be hungry or the fish senses that something is not right.

Fish have the neurological potential to learn and remember. As they age their experiences increase and their ability to become more discriminatory increases as well. Adding scent to a lure can address this issue.

Over the past fifty years a lot has been learned about fish. Fish have both a sense of smell (transmitted through an olfactory nerve) and a sense of taste (transmitted through non-neuronal epithelial cells). The sense of smell connects to the brain regions where the signals can be evaluated, combined and stored in memory. This system is the one that allow fish to distinguish between similar types of food. While fish are feeding generalists they do have a keenly developed ability to identify and locate a range of foods based on their nutritive values. In contrast, the sense of taste is more likely to mediate simple, reflective behaviors. When a taste is appropriate a swallow reflex is initiated, but when a taste is offensive the fish will reflexively expel the contents of the mouth. This reflex is not mediated by a higher neural process and as a result the reflex reaction takes very little time.

Fish and other aquatic animals detect, discriminate and respond to a large number of chemicals that have been dissolved in water. Many of these have been studied in a variety of fish species and are clearly classified as odorants (chemical molecules that activate nerves in the nasal passage of fish). In humans the odorants that stimulate the olfactory nerves in the nose need to be volatile or form an aerosol so the chemical can drift through the air, pass through the nostril and interact with the olfactory receptor on a nerve. Olfactory receptors are proteins integrated into the cell membrane, with a small cavity into which the odorant chemical can “dock”. These docking sites are quite specific and allow very little overlap so each nerve is dedicated to smelling a narrow group of molecules. Large molecules such as whole proteins, oil droplets, or crystal clumps of amino acids will not fit in the “docking site”; the molecules must be fully dissolved in water. Unfortunately, many of the chemical stimuli used in artificial baits today have a difficult time meeting this “dissolved in water” requirement.

The world of biologically relevant classes of water-soluble odorants for fish generally includes amino acids, bile salts, nucleotides, polyamines, gonadal steroids and prostaglandins. These have previously been identified as behaviorally relevant olfactory cues and they mediate behaviors ranging from feeding and predator detection to social interactions and reproductive synchrony. However, it is important to recognize that these odorants need to access the cell membranes of the olfactory receptors within the nasal passages of fish as individual molecules in order to initiate a neuronal action potential. Crystalline clumps of molecules cannot properly “dock” with the membrane receptor and initiate a neuronal action potential. It is only when the brain pulls together many different odor signals that the overall interpretation of a “smell” can be determined that then leads to a change in behavior. This ability to pull together multiple odor signals is what tends to mediate the more complex behaviors such as searching for specific foods, courtship behaviors or inciting a strike.

A problem with some existing scent releasing technologies is that they use gels or powders which are transiently present and quick disperse. Therefore, they work for only short periods of time.

Another problem with existing scent releasing technology is that it does not effectively use water to displace the scent releasing components and allow the odorants to release directly into the water gradually.

Another problem with existing systems is they trap the odorant molecules in oil which impedes the ability of the molecules to be solubilized into the water.

Thus, there exists a need for a scent releasing technology that continuously disperses scent into the water while displacing scent components with water which overcomes the above-mentioned problems while providing better and improved overall results.

### SUMMARY OF THE DISCLOSURE

The present disclosure is directed to a scent releasing tab or tape that uses a polymer system that stabilizes and releases individual odorant molecules into the water. This technology places the maximum amount of odorant molecules in the water in the vicinity of the lure and continues to release them over time to incite the fish to strike.

Specifically, the present disclosure relates to a polymeric film impregnated with bait or olfactory stimulatory scent for attracting fish is disclosed as well as uses for the same. An improved polymeric film construct for stabilizing the scent creating substances in a hydratable polymer for release into the area immediately surrounding the lure. The polymeric film comprising a polymeric film that can be adhered to a fishing lure, spoon, spinner, sinker or hook using a repositionable adhesive.

The present disclosure allows the wide range of water soluble amino acids and polyamine attractant molecules to be simultaneously incorporated into a polymeric film that can be reversibly attached to a lure, spoon, spinner, weight or hook. The individual molecules are stabilized with the polymeric film until released into the local environment as the film is re-hydrated in the presence of water. The re-hydration of the polymeric film of the present disclosure prevents the scents from becoming totally encased in the plastic or similar material.

One embodiment of the disclosure is a unique polymeric film laminated to an adhesive layer to form a tape-like product that can be applied to the surface of a lure. The product disperses feeding attractants and/or stimulants around the lure, typically over 30 minutes or longer depending on conditions. The polymeric film stays with the lure and prevents the tendency to over apply scents or prevent the rapid dispersion of scents placed loosely as a liquid on the outer surface of lures. The polymeric film can be removed and changed as needed.

Another embodiment of the disclosure is it can be applied to a lure to enhance a fisherman's favorite lure. There is no mess, no ooze, no aerosol spray, no spills, no lure clean-up, no oily damage to surrounding surfaces, and no dirty smelly tackle boxes.

A problem is to determine the sufficient amount of amino acid to be dispersed into the water. Nerve testing has indicated that the sensory threshold (minimal concentration that elicits a nerve response) for amino acids to activate a population of olfactory nerves is a concentration of about 20 nanomolar [a very small number of amino acid molecules] per unit water volume. Another issue is to determine how the amino acids are converted into a nanomolar concentration. A sample was taken of 1 ml of scent in 49 ml of water. This is a lot more amino acids or scent than would be placed on a lure, and is placed into a very small volume of water. To normalize this data it is possible to calculate the actual weight of amino acids present in 1 ml of the original product; this calculated weight of amino acids averaged 50 mg over the six solutions tested that did not include oils. For a water column of 10 feet long by 1 square foot in area, the total volume would be 10 cubic feet; or about 283 liters in water volume. 50 mg of scent placed into 10 cubic feet of water should result in 290 nanomolar in concentration; or enough amino acid to keep the threshold above the minimum in about 100 to 150 cubic feet of water (i.e., 1 square foot in area of over 100 feet long). That is, this assumes that the amino acids that were sprayed on the lure stay on the lure as it is pulled through the water for 100 feet and are released over time. But the addition of oils to help keep the amino acids with the lure does not let the amino acids move into the water column, and without the oils, most of the amino acids would wash off immediately, resulting in that the second cast would be without scent. See FIG. 1 for an amino acid assessment method.

Plastic baits have very seductive movement in water, however, most of these plastic baits are not able to become hydrated so that any potentially stimulatory chemicals molded into them cannot migrate to the surface or into the water surrounding the bait. Multiple plastic baits containing amino acids were soaked in 10 mL of water for 30 minutes. In all but one case the levels of amino acids released were not detectable; and in the one case where amino acids were present they were at very low levels. This makes it very difficult, if not impossible, to cast a scented plastic bait into the water and have detectable levels of amino acids throughout a larger column of water. See FIG. 2 for amino acids eluted in plastisol baits.

Other existing baits are cellulose baits where the soft lure is soaking in a liquid that contains the odorant molecules (amino acids; and other molecule). Unfortunately, when these were tested, a great deal of variability in effectiveness was found. When they were tested, some of these cellulose baits released very large quantities of amino acids; one example was 56 mg. A release of 56 mg is sufficient to reach a stimulation threshold in a water column 150 feet long and 1 square foot in area. Furthermore, only three of the six cellulose baits tested showed good release of amino acids over time. See FIG. 3 for amino acids eluted for cellulose baits.

The delivery of olfactory stimuli to incite activity in fish is an ideal opportunity to use the release technology of the present disclosure. More particularly, the release technology of the present disclosure has been developed for use in situations where a molecule's effectiveness is enhanced by delivering it as an individual molecule. To accomplish this, the molecule is embedded in a polymer structure that stabilizes the molecule when in a dry state and the releases it from the polymer in the presence of a hydrated state. The method incorporates water soluble molecules with a net H⁺ acceptor character into a hydrophilic polymeric structure.

Another embodiment of the disclosure is the choice of polymers, the process by which they are blended, and the process by which the odorant molecules are loaded in the polymers. By using a specific blend of water absorbing polymers, a strong film is created that easily and quickly opens up in the presence of water to create channels for the odorant molecules to migrate through. As the layers are formed, the polymers entangle and entrap each other to create a uniform film with the strength necessary for hours of use. Finally, the ways that the pre-dissolved amino acids interact with the polymers assure that individual odorant molecules are available to rapidly activate the nerves in a fish's nasal passage.

In another embodiment of the disclosure, described is a scent tape or tab comprising an active layer; an adhesive layer; a barrier layer; and a removable release liner adjacent to the adhesive layer.

In still another embodiment of the disclosure, described is a scented fishing lure, the lure comprising a fishing lure; and a scent tape or tab comprising an active layer comprising an active agent; a barrier layer; and an adhesive layer; wherein the adhesive layer of the scent tape reversibly secures the scent tape to the fishing lure.

In still yet another embodiment of this disclosure, described is a method of using a scent tape or tab for fishing, the method comprising peeling the tape off a plastic release liner; applying the tape to a fishing lure; activating the tape by casting the lure into water; and removing the tape from the lure.

Still another embodiment of the disclosure is the odorant molecules are available to the nasal passage of the fish without being trapped into oils or loaded as insoluble crystals.

Another embodiment of the disclosure is 15 to 30 percent of the active layer contains odorant molecules that can migrate to the surrounding environment.

Still other embodiment of the disclosure will become apparent upon a reading and understanding of the following detailed description.

### BRIEF DESCRIPTION OF THE DRAWINGS

FIG. 1 is a chart listing an amino acid assessment method;

FIG. 2 is a chart listing amino acids eluted in plastisol baits;

FIG. 3 is a chart listing amino acids eluted in cellulose baits;

FIG. 4 is a chart listing amino acids eluted in Rubigo films;

FIG. 5 is a schematic of the layers of a scent tape or tab in accordance with a preferred embodiment of the disclosure;

FIG. 6 is a schematic showing the layers of the scent tape or tab with the release liner;

FIG. 7 is a schematic of the scent tape or tab of FIG. 6 showing the release liner removed;

FIG. 8 is a schematic of the scent tape or tab of FIG. 7 showing hydration of the tape;

FIG. 9 is a schematic of the scent tape or tab attached to a hard lure; and

FIG. 10 is an illustration of a sheet of scent tapes or tabs.

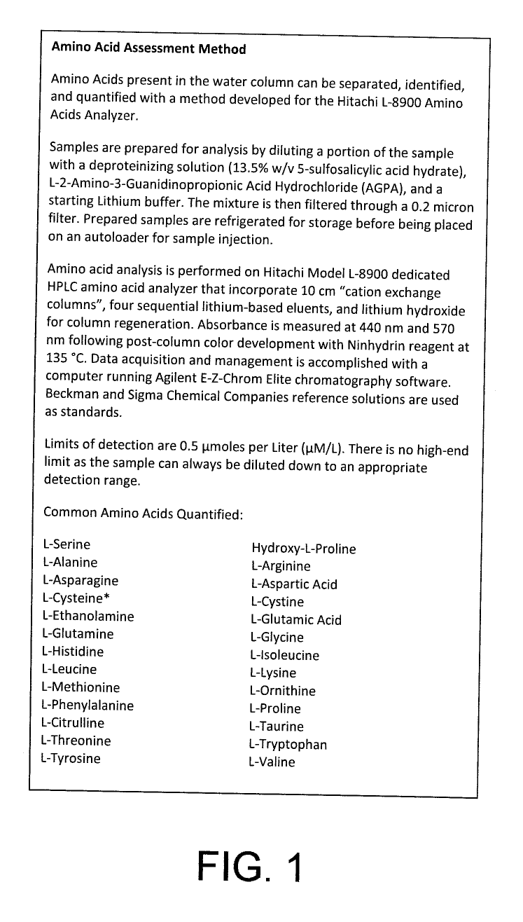

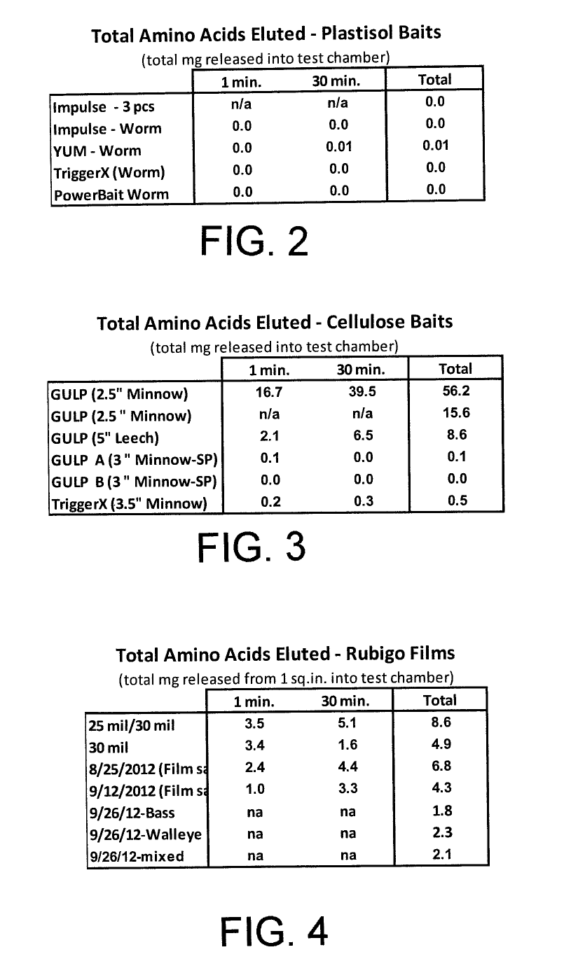

### DETAILED DESCRIPTION OF THE DISCLOSURE

Films may be prepared for release of an active agent into the environment. The films co-located on a lure are translucent to allow visualization of the lure and preservation of the visual sensory cues. Films may be used to influence the chemo-stimulatory area in its surrounding environment. Further, the traits in the film allow for control of interaction between the environment and the fish attractant containing film. One such method is through the regulation of the release kinetics from the film.

Films may, for instance, be used to deliver amino acids, polyamines, prostaglandins or other pheromone molecules that function as fish attractants or chemo receptor stimulants. One method of delivery involves delivering of L-arginine from one or more lures, spinners, spoons, weights or hooks.

An application of the film is a system for delivery of an olfactory stimuli or other active agent to the environment surrounding a fishing lure. In use, a film may be applied to a lure. The term lure refers broadly to a device, artificial bait, natural bait, system or process used to attract and or capture fish. The term film refers to a thin flexible sheet, such as with a hardness of about 80A Durometer.

Films may, for instance, comprise an olfactory stimulatory agent. The film is applied to a lure and the olfactory stimulant, e.g., an amino acid such as L-arginine, is delivered to the local environment around the lure.

The disclosure is a scent strip that can easily be placed on any hard bait. The tape can be available in multiple sizes and is adhesive-backed. The scent remains with the lure rather than floating away, and the tape doesn't interfere with the functionality of the lure, and each tape provides up to 60 minutes of fishing. Its accurate dosage is water activated, so lure preparation can be done ahead of time. Thus, the thin, clear tape can be cleanly removed when it's time to re-apply. No mess and no waste is involved.

Specifically, the disclosure uses a polymer film that stores and releases amino acids and other active ingredients selected to stimulate the olfactory senses of fish and delivers scent from the surface of any hard bait, slowly releasing molecules on the scent tape as they become wet.

The release technology of the present disclosure entraps the amino acids into the dispensing film. The amino acids are released over time and stay in the area or vicinity of the lure.

The film technology of the present disclosure has shown the ability to integrate amino acids into the polymers at a very high density. Since hard crank baits are not provided with any scent, this release technology is able to add odorants to various hard lures. The release of amino acids in the vicinity of the lure can stimulate the fish to complete the strike. The amount of amino acid released from even the smallest pieces of scent bait tape consistently exceeds the amount released from the existing plastic soft baits. Further, the scent released exceeds the amount released in many of the cellulose baits tested. See FIG. 4 for amino acids eluted for Rubigo films.

Some water soluble amino acids are known to generate odorant molecules that can be sensed by fish. When applied to an artificial hard lure, the odor or scent attracts and increases the chances of catching fish.

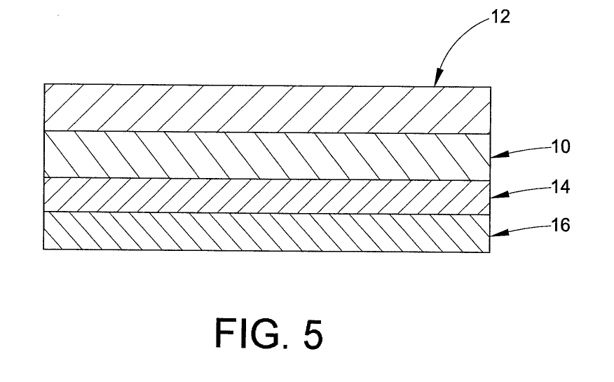

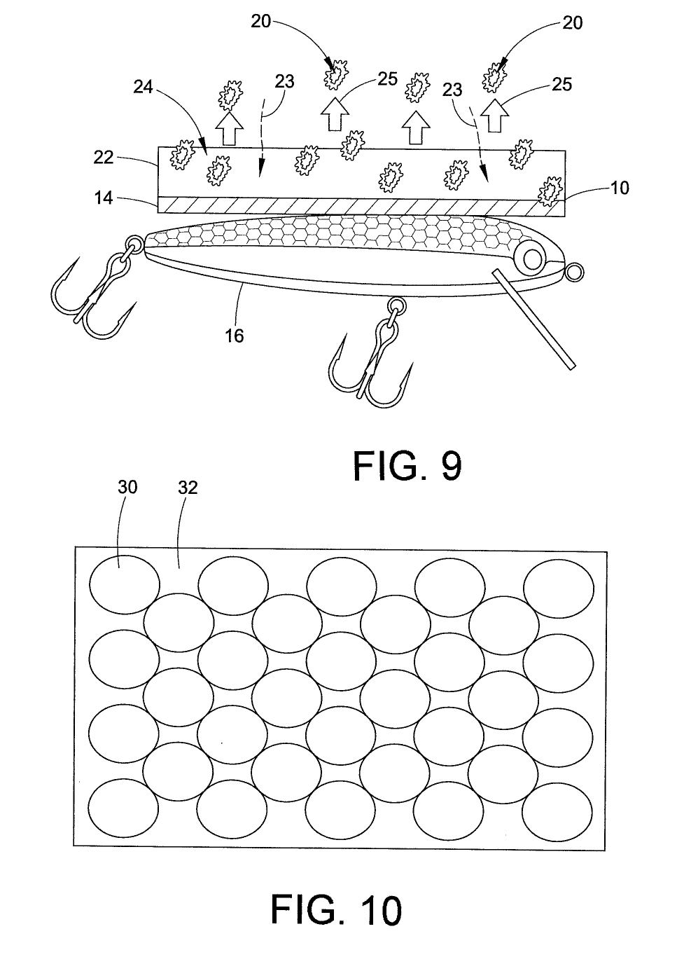

Referring now to FIGS. 5, 6, 7 and 8, in particular embodiments of the present disclosure, a scent tape or tab has a layer of plastic barrier film 10 used to provide a barrier between the active layer of dissolvable natural attractant 12 and an adhesive coating layer 14 which is attached to a removable release liner 15. Referring to FIG. 9, the adhesive layer 14 is then attached directly to a hard lure 16 after the release liner 15 is removed.

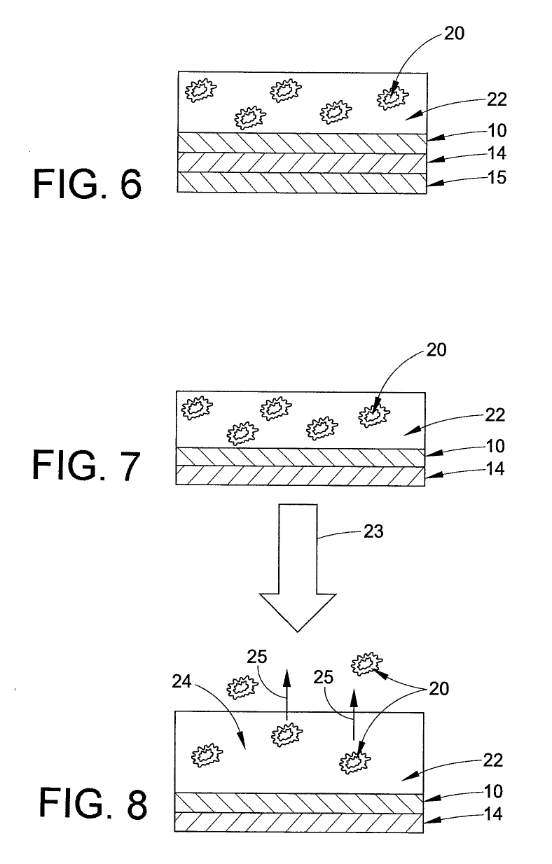

According to some embodiments of the present disclosure, water soluble scent attractants (i.e., amino acids) are embedded into a swellable, or water absorbing, polymer matrix, which remains stable until activated by water. Specifically, referring now to FIGS. 6, 7 and 8, a scent tape or tab according to one embodiment of the present disclosure includes an active agent such as a scent attractant (i.e., amino acids) 20, polymer binders 22, a barrier film 10, an adhesive layer 14, and a release liner 15. In other embodiments, the tape may comprise a single-layer film. FIG. 8 shows as water enters the tab (represented by arrow 23) and the tab becomes hydrated, the scent attractant 20 are displaced and gradually are dispersed into the water. The concentration of the scent attractant 20 becomes entrapped at the surface of the binders before it is released.

In particular embodiments of the present disclosure, the active layer of the scent tape comprises a continuous hydrophilic polymer matrix. In some embodiments, the matrix contains covalent or non-covalent crosslinks so that it is insoluble in water, even though it is made with hydrophilic materials.

The matrix may further comprise a dispersed discontinuous phase, such as a material distributed through the matrix, with the material being distinct from the matrix. The discontinuous phase may be, for instance, drops, particles, or self-assembling domains. An example of a self-assembling domain is a hydrophobic block or a micelle. An example of a drop is a liquid, sol, or gel. Examples of particles are liposomes, nanoparticles, microparticles, capsules, microcapsules, and solid beads. In some embodiments, the discontinuous phase is a hydrophilic particle. The hydrophilic particle may be, e.g., a cross-linked particle that it is swellable in polar solvents. The term hydrophilic refers to a material that, when not in a cross-linked state, is soluble in water at a concentration of at least 1 g/100 mL in an aqueous solution. In the case of a cross-linked hydrophilic material, the material would swell in aqueous solutions and the crosslinks would prevent dissolution.

In some embodiments according to the present disclosure, the active layer is a continuous hydrophilic matrix that comprises a plurality of discontinuous hydrophilic domains that are at least twice as swellable in aqueous media as the continuous hydrophilic matrix. In particular embodiments, the discontinuous phase comprises a plurality of polymer particles, such as cross-linked polymers. The plurality of polymer particles may comprise: cross-linked polyacrylic acid, cross-linked polyvinyl alcohols, cross-linked vinylpyrrolidinone, and cross-linked polyethylene glycols. As used herein, polyethylene glycols, or PEGs, include polyethylene oxides containing any termini unless otherwise indicated.

In particular embodiments, the discontinuous phase may comprise polymers with a very high molecular weight.

In other embodiments, the discontinuous phase may comprise low molecular weight polymers. In further embodiments, the discontinuous phase may comprise uncross-linked polymers.

In some embodiments, the continuous phase of the active layer may comprise: polyvinyl alcohol; polyvinylpyrrolidinone, polyalkylenes, polyethylene glycols, hydrophilic polyurethanes, hydrophilic polyacrylates, and hydrophilic polymethacrylates. In some embodiments, materials with pendant carboxylic acids may be used to form, or be part of, the continuous phase or discontinuous domains. These polymers may be purchased and reacted to make the films, or synthesized. For instance, methacrylic acid monomers may be reacted with other monomers to form polymers using known techniques.

In particular embodiments, the invention according to the present disclosure may include a barrier film 10. In some embodiments, the barrier film may comprise polyethylene terephthalate (PET) or other similar polymers with barrier properties.

In particular embodiments, the adhesive layer 14 is preferably a removable adhesive with an average peel value at or around 750 g/inch from stainless steel. In such embodiments, the adhesive layer is designed to secure the scented tape to a surface for 1 to 2 hours under water and then be removed cleanly after use.

In other embodiments, the tape or tab according to the present disclosure may be made with self-adhesive properties. In such embodiments, the active agent and the barrier layer can be incorporated into the adhesive layer. In particular embodiments, the adhesive may be applied to all or a portion of a side of a film, such as covering one side of a film or covering a peripheral portion of a side of a film. In particular embodiments, the adhesive may be pressure-sensitive.

In further embodiments, the tape or tab may be attached to a member that receives the adhesive, such as a cardboard or elastic member that is tied to the tape. The tape may be prepared with a release liner (or backing member) 15 that is removable by a user to expose the adhesive at the time of use. In embodiments according to the present disclosure, the tape comprises a single-layer film or a film with a plurality of layers wherein at least one of the layers include a polyurethane continuous matrix and a plurality of discontinuous domains formed by a cross-linked polyacrylic acid polymer. In particular embodiments, the ratio of the combined urethane is preferably 80:20 by weight of the soft polyurethane to the rigid polyurethane. Although the molecular weights of the two polyurethanes differ, the difference of the chemical composition lends to the unique properties of the film, varying the percentage of the two polyurethanes in the system reduces the tack of the active layer. This is beneficial in the converting and packaging of its product. In particular embodiments, the total ratio of combined polyurethane to polyacrylic acid is preferably 70:30 by weight. In further embodiments, the ratio of polyacrylic acid to the active agent 20 is at or around preferably 50:50 by weight.

According to some embodiments, the effectiveness of the present disclosure is the combination of polymer phases, such as polyacrylic acid, the swellable polymer, and the combined polyurethanes, which facilitate and control complete migration of the water into the polymer matrix. The interaction of the discontinuous phase and the amino acids (i.e., scent attractant 20) is disturbed as water 23 hydrates and fills polymer matrix 24 thereby swelling the polyacrylic acid and displacing the amino acids and thus allowing the amino acids (i.e., scent attractant 20) to migrate out of the film into the water (as shown as arrows 25 in FIGS. 4 and 5) leaving behind a scent trail over a prolonged period of time. The continuous phase helps the film stay formed and intact for the duration of use. After about one hour or 60 minutes of exposure to water, the entire tape can be removed from the substrate and responsibly discarded.

Different combinations of active agents 20, or amino acids, can be used or mixed to attract different species of fish. For example, various amino acids, or amino acid containing extracts, can be used such as: alanine, proline, lysine, taurine, porcine bile salts, glycine, and arginine. These may be in the continuous phase and/or discontinuous phase. For instance, collections of particles may be prepared that each comprise different agent and particles from a plurality of the collections may be added to the film. In other embodiments, a first active agent may be in a continuous phase and a second agent in a discontinuous phase.

In particular embodiments, a tape according to the present disclosure may have a first agent in a polyacrylic acid particle or other subdomain within a matrix and in that same matrix may have a second agent in a second polyacrylic acid particle or other subdomain. A method to make such a film is by first loading the polyacrylic acid particle with the agent (or incorporating the agent at the time of formation) and then blending the particle into a solution with polyurethane or other hydrophilic polymers to form the active layer of the tape.

In some embodiments, a suitable ratio of active agent molecules to carboxylic acid groups in a layer or a domain of a layer may be 1:n, wherein n is between 3 and 200. Artisans will immediately appreciate that all the ranges and values within the explicitly stated ranges are contemplated, e.g., n between 5 and 50, or 10 and 24. The ratio may also be expressed in terms of molecular weight, wherein the relative molecular weights of the active agent to the carboxyl groups is between 1:1 and 1:500. Artisans will immediately appreciate that all the ranges and values within the explicitly stated ranges are contemplated, including between 1:1 and 1:10.

In particular embodiments, polymers are chosen that comprise a minimum density of pendant carboxylic acid groups, including polymers that have no more than about 2 to about 50 carbon bonds of separation on the polymer backbone between the carboxylic acid groups. Artisans will immediately appreciate that all the ranges and values within the explicitly stated ranges are contemplated, e.g., between 2 and 10 carbon bonds. The description in terms of carbon bonds refers to a distance; polymers with backbones besides C—C bonds may be used.

Variations to the disclosure are also contemplated. For example, additional scent designed to appease or appeal to the angler can be added to the polymer matrix in the form of fragrance oil. This is done at low concentrations and makes up less than 2% of the final composition. The concentration of the scent can be entrapped at the surface of the polymer binder. This could be done using a variety of scents such as: anise oil, fish oil, lavender, garlic, coffee, etc. These scents are to appeal to the user and usually are not relevant to the fish itself.

Referring to FIG. 10, different shapes of scent tabs or tapes 30 can be produced using different die tooling during converting. The tape 30 can be attached to a sheet 32 and removed one at a time. A variety of shapes and sizes can be made to fit various types of hard lures. Oval tabs 30 are shown, but round, square, rectangle shapes are also contemplated. Larger tabs may be used for lures for attracting larger fish, such as salmon. It is also contemplated that tabs could be supplied in a roll form and supplied on a plastic or fiber core.

Furthermore, according to the present disclosure, the scent tape or tabs are flexible and thin. Flexibility contributes to ease of use for the fisherman that places the film onto a lure. Thinness contributes to flexibility and assists in keeping the film in place on an exposed surface of the lure, with a thin film being less likely to be displaced in use on a lure.

The present disclosure is also directed to processes for manufacturing the disclosed scented tapes. Compositions for making films typically involve dispersing or dissolving a small weight percent of a polymer in the solvent. For instance, hydrophilic polymer particles may be used in an aqueous solution phase, in an amount from about 0.5 percent by weight to about 3 percent by weight, e.g., as an emulsion, solution, or mixture, although higher and lower amounts may also be used. For example, a crosslinked-acrylic-copolymer particle may be present in a solution in a range of from about 1 percent by weight to about 2 percent w/w. These ranges are for guidance in preparation of suitable compositions and are exemplary; other concentrations may be used. The continuous phase may also be in the same solution phase, in an amount from 0.5 percent by weight to 3 percent by weight, such that after the solvents have evaporated the solid composition of the dispersed phase within the continuous phase would be about 50 percent w/w solid composition.

One process to prepare films involves mixing a first polymeric material with a second matrix material that forms a continuous matrix. The mixture is cast, molded, or otherwise distributed so that the continuous matrix is allowed to form around the first polymeric material. The resultant film has a continuous matrix with discontinuous subdomains dispersed throughout it. The discontinuous domain may be, for instance, crosslinked polymers or particles (nanoparticles or microparticles). The continuous domain may be, for instance, a thermoset, thermoplastic, or crosslinked polymer. The first polymeric material may comprise one or more precursors or polymers that form the continuous domain, e.g., precursors to a polyurethane, a resin, a rubber, free radical polymerizable polymers, or precursors that chemically react.

Additionally, other matrices with free carboxyl groups can be made by grafting to other polymer backbones (e.g. cellulose, polyvinyl alcohol, polysaccharides) with chloroacetic acid in base to form the corresponding carboxymethyl cellulose, carboxymethyl polyvinyl alcohol, or carboxymethyl polysaccharide.

A combination of solvents is used to facilitate the dissolution of all amino acids into solution during the manufacturing process. These are further adjusted to ensure uniform mixing into the dissolved polymer matrix. The coating is cast and dried to form the film.

The present disclosure is also directed to methods of utilizing the described embodiments. According to some embodiments, such methods comprise the following steps: a) peel the tape off the plastic release liner; b) apply the tape to any hard lure, spoon, crank bait, etc.; c) cast the lure, thereby activating the tape when the lure and tape enter the water; and, d) after use, remove the sticker/tape from the lure and discard properly. The present disclosure is designed to attract the broadest amount of fresh water species such as, crappie, bass, muskie, northern pike, walleye, perch, and lake trout. It is also contemplated that the disclosure could be possibly used for salt water fishing as well.

The disclosure is directed to fish lures, but could be used for other applications such as highly-breathable medical wound care dressings, or certain transdermal drug delivery patches. In these applications, the medicine or drug to be delivered would be attracted to or dispensed toward the user's skin by the natural moisture found in the user's skin. That is, the medicine or drug delivery would be inward toward the user, rather than outward as with the fish scent. Thus, in this application there may not be a barrier film layer.

In summary, one aspect of the disclosure is a scented bait tape for hard fishing lures (See FIG. 9). Another aspect of the disclosure is a water activated formula that releases a scent that attracts fish. Still another aspect of the disclosure is using natural amino acids that are ecologically safe. Another aspect of the disclosure is the scent stays with the lure and does not float away. Another aspect of the disclosure is a clear, thin tape which does not interfere with lure's action or color. Another aspect of the disclosure is that it is simple to apply by just peeling and sticking the tape to the lure. Each tape is water activated and releases scent for 60 minutes. Another aspect of the disclosure is it does not lose any potency once opened and activated.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the disclosure and the appended claims or the equivalents thereof.

1. A scent tab comprising:
an active layer;
an adhesive layer;
a barrier layer; and
a removable release liner adjacent to the adhesive layer.

2. The tab of claim 1, wherein the active layer comprises:
a polymer matrix and an active agent stored within the polymer matrix.

3. The tab of claim 2, wherein the active agent is a scent attractant.

4. The tab of claim 3, wherein the active agent comprises at least one amino acid.

5. The tab of claim 3, wherein the active agent is water soluble.

6. The tab of claim 2, wherein the polymer matrix comprises a continuous phase and a discontinuous phase dispersed within the continuous phase.

7. The tab of claim 6, wherein the continuous phase is a hydrophilic polymer matrix.

8. The tab of claim 7, wherein the continuous phase comprises a cross-linked hydrophilic polymer or copolymer.

9. The tab of claim 8, wherein the polymer or copolymer comprises polyvinyl alcohol, polyvinylpyrrolidinone, polyalkylenes, polyethylene glycols, hydrophilic polyurethanes, hydrophilic polyacrylates, hydrophilic polymethacrylates.

10. The tab of claim 6, wherein the discontinuous phase comprises a plurality of drops, particles, or self-assembling domains.

11. The tab of claim 10, wherein the discontinuous phase consists of a plurality of particles, wherein the particles have a mean diameter from about 0.1 micrometer to about 10 micrometers.

12. The tab of claim 10, wherein the discontinuous phase comprises a cross-linked hydrophilic polymer or copolymer.

13. The tab of claim 12, wherein the polymer or copolymer comprises polyacrylic acid, polyvinyl alcohols, vinylpyrrolidinone, and polyethylene glycols.

14. The tab of claim 10, wherein the ratio of swelling upon hydration between the discontinuous phase and the continuous phase is between 1:1 to 100:1.

15. The tab of claim 1, wherein the active layer comprises:
a continuous phase comprising polyurethane;
a discontinuous phase comprising polyacrylic acid; and
an active agent comprising an amino acid.

16. The tab of claim 15, wherein the total ratio of combined polyurethane to polyacrylic acid is 70:30 by weight.

17. The tab of claim 15, wherein the ratio of polyacrylic acid to the active agent is 50:50 by weight.

18. The tab of claim 1, wherein the adhesive layer comprises an adhesive with an average peel value of 750 g/inch from stainless steel.

19. The tab of claim 1, wherein the active layer is also at least one of the barrier layer and the adhesive layer.

20. A scented fishing lure, the lure comprising:
a fishing lure; and
a scent tape comprising:
an active layer comprising an active agent;
a barrier layer; and
an adhesive layer;
wherein the adhesive layer of the scent tape reversibly secures the scent tape to the fishing lure.

21. A method of using a scent tape for fishing, the method comprising:
peeling the tape off a plastic release liner;
applying the tape to a fishing lure;
activating the tape by casting the lure into water; and
removing the tape from the lure.
